(19) United States
(12) Patent Application Publication
(10) Pub. No.: US 2018/0160037 A1
(43) Pub. Date: Jun. 7, 2018

(54) ELECTRONIC APPARATUS, METHOD, AND PROGRAM

(71) Applicants: Kabushiki Kaisha Toshiba, Tokyo (JP); Toshiba Visual Solutions Corporation, Misawa-shi (JP)

(72) Inventor: Masatoshi Murakami, Hamura Tokyo (JP)

(21) Appl. No.: 15/419,702

(22) Filed: Jan. 30, 2017

(30) Foreign Application Priority Data
Dec. 5, 2016 (JP) 2016-236057

(51) Int. Cl. H04N 5/232; H04W 4/02

(52) U.S. Cl. CPC H04N 5/23222; H04W 4/008; H04W 4/023

(57) ABSTRACT

According to one embodiment, electronic apparatus configured to control camera, includes communication circuitry and processor circuitry. The communication circuitry capable of communicating with a first electronic terminal of a first user or a second electronic terminal of a second user, when a plurality of electronic terminals includes the first electronic terminal and the second electronic terminal are located within a first communication distance from the electronic apparatus. The processor circuitry configured to start a capturing of the camera when the first electronic terminal is located outside of the first communication distance, and stop the capturing of the camera when at least the first electronic terminal is located within the first communication distance.

### CROSS-REFERENCE TO RELATED APPLICATIONS

This application is based upon and claims the benefit of priority from Japanese Patent Application No. 2016-236057, filed Dec. 5, 2016, the entire contents of which are incorporated herein by reference.

### FIELD

Embodiments described herein relate generally to an electronic apparatus, a method, and a program.

### BACKGROUND

As a portable electronic apparatus, a smartphone, a portable telephone, a tablet PC, and a wearable terminal device have been come into wide use.

Most of the above portable electronic apparatuses are linked to information specified to a user who carries with or wears it.

The information specified to the user may be classified on the basis of, for example, various viewpoints, for example, family, relatives, comrades, alumna, roommates, and members who are in the same space and belong to a group sharing information in addition to an age and a gender, an ambient circumstance of the user, and information specified to the user. Further, the classification is frequently changed on the basis of the ambient circumstance of the user for example.

The information specified to the user has been already used in control of some of the electronic apparatuses. However, it could not be said that the control of the electronic apparatus classified on the basis of the ambient circumstance of the user and the information specified to the user is sufficiently studied. Further, there is a concern that the control is performed regardless of a user's intention.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 shows an example of a diagram schematically illustrating an example of a relation between an electronic apparatus of an embodiment and elements which relate to the electronic apparatus according to an embodiment;

FIG. 2 shows an example of a diagram schematically illustrating an example of a characteristic operation of the electronic apparatus according to an embodiment;

FIG. 3 shows an example of a diagram schematically illustrating an example of a relation between a control of the electronic apparatus of the embodiment and user-specific information according to an embodiment;

FIG. 4 shows an example of a diagram schematically illustrating an example of a relation between the electronic apparatus of the embodiment and the elements according to an embodiment;

FIG. 5 shows an example of a diagram schematically illustrating an example of a relation between the electronic apparatus and the elements according to an embodiment;

FIG. 6 shows an example of a diagram schematically illustrating an example of a relation between the electronic apparatus and the elements according to an embodiment;

FIG. 7 shows an example of a diagram schematically illustrating an example of a relation between the control of the electronic apparatus of the embodiment and the user-specific information according to an embodiment;

FIG. 8 shows an example of a diagram schematically illustrating an example of a relation between the control of the electronic apparatus of the embodiment and the user-specific information according to an embodiment;

FIG. 9 shows an example of a diagram schematically illustrating an example of a relation between the control of the electronic apparatus of the embodiment and the user-specific information according to an embodiment;

FIG. 10 shows an example of a diagram schematically illustrating an example of a relation between the control of the electronic apparatus of the embodiment and the user-specific information according to an embodiment;

FIG. 11 shows an example of a diagram schematically illustrating an example of the control of the electronic apparatus on the basis of information specified to the elements according to an embodiment;

FIG. 12 shows an example of a diagram schematically illustrating an example of the control of the electronic apparatus on the basis of information specified to the elements according to an embodiment;

FIG. 13 shows an example of a diagram schematically illustrating an example of the control of the electronic apparatus on the basis of information specified to the elements according to an embodiment;

FIG. 14 shows an example of a diagram schematically illustrating an example of the control of the electronic apparatus on the basis of information specified to the elements according to an embodiment;

FIG. 15 shows an example of a diagram schematically illustrating an example of the control of the electronic apparatus on the basis of information specified to the elements according to an embodiment; and

FIG. 16 shows an example of a diagram schematically illustrating an example of the control of the electronic apparatus on the basis of information specified to the elements according to an embodiment.

### DETAILED DESCRIPTION

Various embodiments will be described hereinafter with reference to the accompanying drawings.

In general, according to one embodiment, an electronic apparatus configured to control a camera, comprises: communication circuitry capable of communicating with a first electronic terminal of a first user or a second electronic terminal of a second user, when a plurality of electronic terminals comprising the first electronic terminal and the second electronic terminal are located within a first communication distance from the electronic apparatus; and processor circuitry configured to: start a capturing of the camera when the first electronic terminal is located outside of the first communication distance, and stop the capturing of the camera when at least the first electronic terminal is located within the first communication distance.

Embodiments will now be described hereinafter in detail with reference to the accompanying drawings.

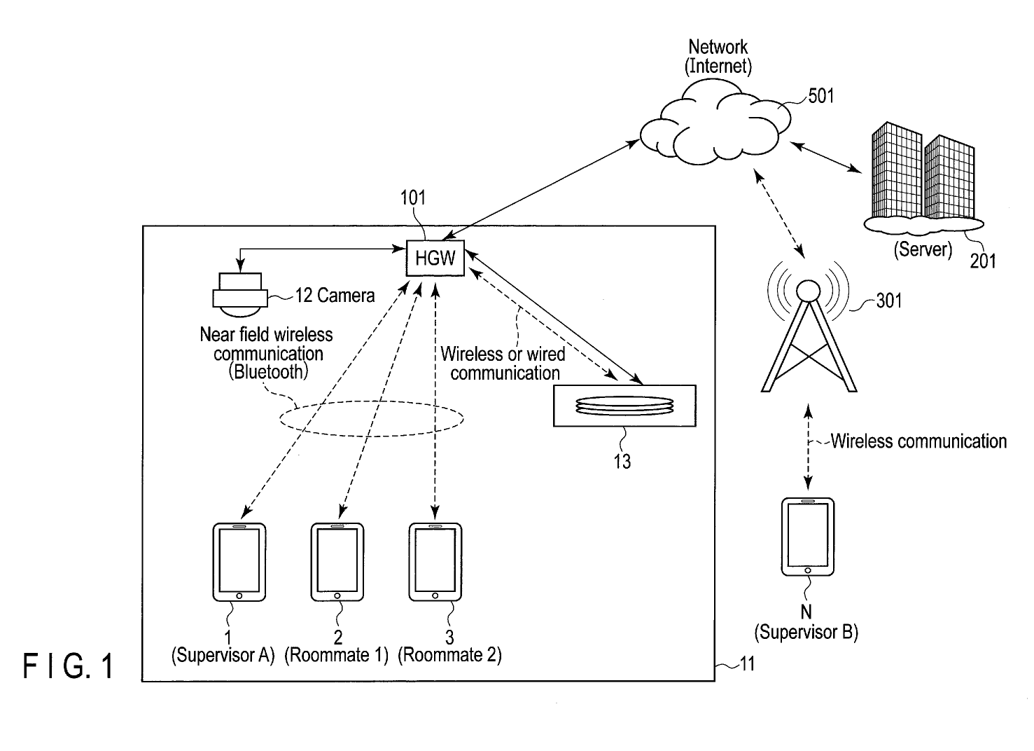

FIG. 1 shows an example of a schematic diagram for describing a relation between an electronic apparatus (for example, a camera which captures an image in a predetermined space such as a living room) according to the embodiment and various elements which are associated with the camera. Further, the acquisition of an image using the camera may be called capturing. In addition, the predetermined space is not limited to the living room, and may be arbitrary place in a house (for example, an entrance hall, a site (outdoor), or a roof). In addition, the predetermined space may be a classroom or an auditorium of a school, a ground or a passage (including a public road) accompanying a school, a station or a bus terminal (airport), a commercial facility or a movie theater or a space nearby, or a floor of a factory or a space within a certain range in a site.

As illustrated in FIG. 1, a camera 12 is placed at a predetermined position in a living room 11. The camera 12 makes a communication with a home gateway (hereinafter, referred to as HGW) 101 in the living room 11. The HGW 101 is connected to a storage device 13, and can store a video captured by the camera 12 in the storage device 13. In addition, the HGW 101 makes a communication with an external service server 201 through a network (Internet) 501. Further, the HGW 101 may be integrally provided with the camera 12. In addition, the storage device 13 may be integrally provided with the camera 12. The HGW 101 can move by itself for example, and may be integrally provided with the camera 12 and the storage device 13.

The HGW 101 can transfer information between the user (also referred to as supervisor) locating in the living room 11 or in the house or the site and portable terminal devices 1, 2, . . . , and N (N is a positive integer) carried by family members of the user or visitors through a near field wireless communication (for example, Bluetooth (registered trademark). In addition, arbitrary communication system complying with a standard such as Wi-Fi (Wireless Fidelity) may be used as the near field wireless communication.

The portable terminal devices 1, 2, 3, . . . , and N are, for example, smartphones, portable telephones, tablet PCs, or wearable terminals, and may be any form of devices as long as the device is carried by the user (or attached to the user's body). The portable terminal devices 1, 2, 3, . . . , and N can transfer information with respect to the server 201 through a public telecommunication network 301 (for example, a portable line) in a communication range of the near field wireless communication. Each of the portable terminal devices 1, 2, 3, . . . , and N can provide the HGW 101 with age information which is obtained from the date of birth registered in the device or the date of birth linked to the portable terminal device. In other words, the HGW 101 acquires the information specified to the owner from the respective portable terminal devices which are detected using the near field wireless communication.

Further, in the example of FIG. 1, it is assumed that the users stay in the living room 11, for example, a supervisor A (the portable terminal device 1) who is a father, a roommate 1 (the portable terminal device 2) who is a family member of the user, and a roommate 2 (the portable terminal device 3) who is a family member of the user. The HGW 101 communicates respectively with the portable terminal devices 1, 2, and 3 through the near field wireless communication. In addition, the HGW 101 can transfer the information with respect to the portable terminal device N carried by the user who is out of the communication range of the near field wireless communication (that is, the outside of the living room 11). Further, in the example of FIG. 1, the roommate 1 (the portable terminal device 2) is, for example, a 17-year-old child of the supervisor A, and the roommate 2 (the portable terminal device 3) is, for example, a 10-year-old child of the supervisor A. In addition, in the example of FIG. 1, a supervisor B (the portable terminal device N) who is a mother (a family member of the user) not staying in the living room 11 communicates with the HGW 101 through a communication medium 301 of a long-distance wireless communication (portable telephone line) or a wired communication (public communication line) and the network 501. Therefore, in the example of FIG. 1, the supervisor B (the portable terminal device N) who does not stay in the living room 11 is not possible to receive and reproduce a video captured by the camera 12. Naturally, in a case where the supervisor not staying in the living room 11 is the supervisor A, the supervisor A is not possible to receive and reproduce the video captured by the camera 12 through the portable terminal device 1 carried by the supervisor A.

The camera 12 captures the inside of the living room 11 under the control of the HGW 101. As the control of the HGW 101, there are a temporary suspension of the capturing of the camera 12 (stop of the camera 12) and a start of capturing in a non-capturing state. Further, in a case where the HGW 101 has a voice reproduction function, a voice message to notify an operation situation such as “the capturing is stopped” or “the capturing starts” may be output. The output of the voice message may be limited to a case where only the registered portable terminal device is detected. Therefore, in a case where the visitor stays together, it is possible to suppress that the visitor is carelessly heard of the voice message. In addition, in a case where the HGW 101 has a reception function (voice input function) for a voice input, the HGW 101 receives an instruction input such as “Stop capturing” or “Capture” from someone who stays in the living room 11, and may transmit a control command to the camera 12. In such a case, an unexpected operation caused by an instruction input for fun of a child is suppressed for example. Therefore, the voice and a feature of a person who is authorized to issue the instruction input are desirably stored in advance. Further, the voice instruction may be received only in a case where the supervisor stays therein (a case where the portable terminal device of the supervisor is detected in the living room 11). In such a case, the voice instruction may be received in a case where only the supervisor stays in the living room. In addition, in a case where the supervisor and the persons other than the supervisor stay together, and someone other than the visitor and the child (for example, the supervisor is the father) stays together, the voice instruction may be received even in a case where the wife of the supervisor (that is, the mother) stays together. Further, in a case where the voice and the feature (for example, voice print) of the person who is authorized to issue the instruction input is stored in advance, and the instruction input is received by a person having a voice not registered, the capturing may be controlled to start automatically. In addition, an utterer (a person staying in the living room 11) is specified using the voice print, and it may be determined whether the voice instruction is validated or invalidated. In this case, in a case where the detected portable terminal device is not matched to the feature of the voice of the utterer who is expected to be linked to the portable terminal device, the voice instruction is desirably invalidated.

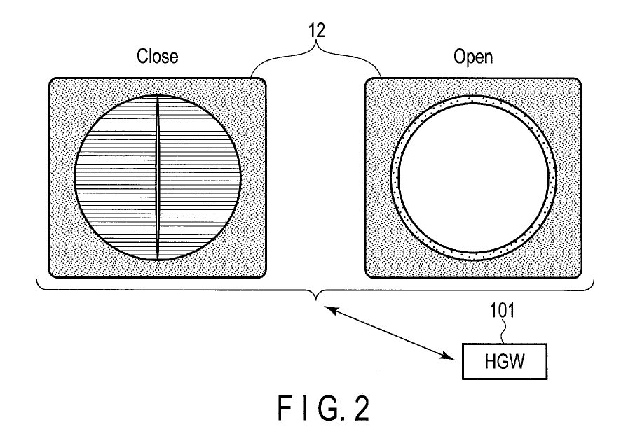

The camera 12 can be expressly known to the user placed in the living room 11 about that the camera is not capturing (in non-operation) by closing a shutter as the example illustrated in FIG. 2.

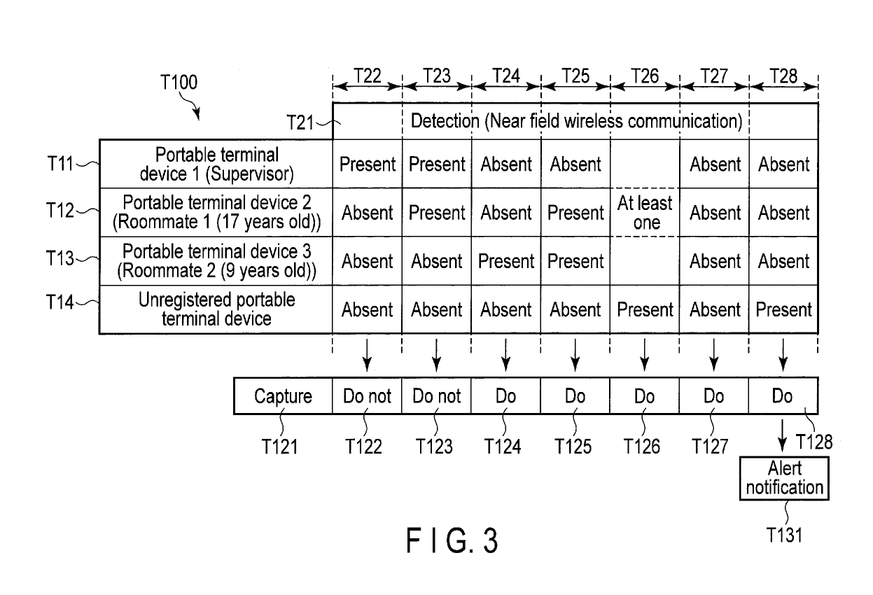

FIG. 3 is a diagram schematically illustrating an example of a determination on whether the camera is capturing or not. Further, the determination on the presence/absence of the capturing may be performed by the HGW 101, or may be performed by the server 201 through the network 501.

A determination table T100 illustrated in FIG. 3 contains specific information T11, T12, . . . for respective portable terminal devices 1, 2, . . . , and N, and determination conditions T21, T22, . . . , and T27 on the basis of the number (the presence/absence) of the portable terminal devices 1, 2, . . . , and N.

In the detection result T21, in a case where only the portable terminal device 1 (the supervisor A) can be determined in the living room 11 (T22), the capturing T121 of the camera 12 is set to “Do not” (T122). In the detection result T21, in a case where the portable terminal device 1 (the supervisor A) and the portable terminal device 2 (the roommate 1) are detected in the living room 11 (T23), the capturing T121 of the camera 12 is set to “Do not” (T123). In other words, in a case where it is determined that only the supervisor A (for example, the father) stays in the living room 11, or someone else other than the supervisor A stays therein, the capturing of the camera 12 is not required, and the capturing of the camera is stopped according to T122 or T123. Therefore, it is possible to overcome an undesirable situation for the supervisor A such that the camera 12 keeps on capturing even though the supervisor A stays in the living room 11. In addition, this is also effective to suppress that an outsider peeps into a situation in the living room 11 (house) by an undesired access. Further, at this time, as illustrated in FIG. 2, the shutter of the camera 12 is closed to let the supervisor A in the living room 11 or the roommate clearly know that the camera is “not capturing”, so that a sense of security can be provided.

In the detection result T21, in a case where only the portable terminal device 3 (the roommate 2) is detected in the living room 11 (T24), or in a case where the portable terminal device 2 (the roommate 1) and the portable terminal device 3 (the roommate 2) are detected (that is, the supervisor A is absent) (T25), the capturing T121 of the camera 12 is set to “Do” (T124 or T125).

Further, herein, the condition for operating the camera 12 has been described about a case where only the child (only the roommate 2 or only the roommates 1 and 2) stays. However, the above description is applicable even to a case where only an aged person stays for example. In this case, for example, a falling accident or such a symptom can be detected according to an unpredictable behavior of the aged person.

In the detection result T21, in a case where at least one of the portable terminal devices 1, 2, and 3 and an unregistered portable terminal device (referred to as portable terminal device X for convenience) are detected in the living room 11 (T26), the capturing T121 of the camera 12 is set to “Do” (T126). Further, the unregistered portable terminal device X may be estimated as a visitor (a friend of the roommate) for example. However, it is desirable that the roommate is assumed as a child (the detectable portable terminal devices are the portable terminal device 2 or 3), and the capturing of the camera 12 is not stopped. In this case, in a case where it is estimated that the portable terminal device X is a visitor who is allowed to enter the room by the supervisor A (for example, in a case where the unregistered portable terminal device X and the portable terminal device 1 (the supervisor A) are detected), the capturing of the camera 12 may be stopped.

In the detection result T21, in a case where there is no portable terminal device detected in the living room 11 (the supervisor A and the family of the supervisor A do not stay) (T27), the capturing T121 of the camera 12 is set to “Do” as a house-watching (crime prevention) mode (T127).

In the detection result T21, in a case where only the unregistered portable terminal device X is placed in the living room 11 (the supervisor A and the family of the supervisor A do not stay) (T28), the capturing T121 of the camera 12 is set to “Do” (T128). In this case, it is estimated that an outsider except the supervisor A and the family of the supervisor A stays, an alert notification T131 is desirably transmitted (issued) to the supervisor A (or the supervisor B).

Further, for example, in a case where a pet is left and all members having the registered portable terminal devices go outside (the number of detecting portable terminal devices is “0”), the camera 12 can be operated by the registered portable terminal device of someone else among the members. In such a case, one of the members who go outside may operate the camera 12 by a user's setting for example. In addition, the video captured by the camera 12 can be confirmed (be viewed) at every time (at arbitrary timing) from the registered portable terminal devices. In such a case, a using application (program) may be downloaded to the respective portable terminal devices in advance, and an application (program) such as “Pet monitoring tool” may be used every time through the server 201.

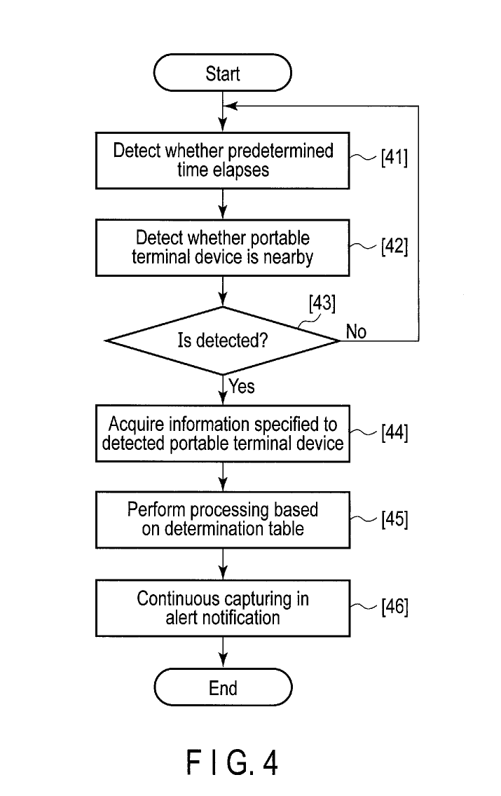

FIG. 4 illustrates the determination on the presence/absence by the camera according to the determination table illustrated in FIG. 3 in a software manner. Further, the determination on the presence/absence of the capturing may be performed by the HGW 101, or may be performed by the server 201 through the network 501.

In FIG. 4, it is detected whether there is at least one portable terminal device in the living room 11 or in a predetermined range [Block 42]. This detection is performed every time when a predetermined time elapses in Block 41 (a detection interval elapses).

In a case where at least one portable terminal device (the presence) is detected [Block 43—YES], the information specified to the detected portable terminal device and a circumferential situation of the terminal are acquired [Block 44], and the execution (capturing)/non-execution (non-capturing) of the capturing T121 of the camera 12 is determined on the basis of the determination table [Block 45].

In a case where the determination by [Block 45] is the alert notification (T131 (FIG. 3)), a continuous capturing is performed by the camera 12 [Block 46]. Further, in a case where it is not possible to detect the specific information from the detected portable terminal device in [Block 44], the alert notification may be issued right away (T131 (FIG. 3)).

Further, for example, the HGW 101 estimates the age of a captured person from the video captured by the camera 12, and the condition for the operation of the camera 12 may be changed on the basis of the estimated age. For example, in a case where there is captured a person who is estimated as an aged person regardless of that the unregistered portable terminal device is not detected in a state where only the child stays, the alert notification is issued right away and the camera 12 is operated. In such a case, the captured video is desirably stored in the storage device 13.

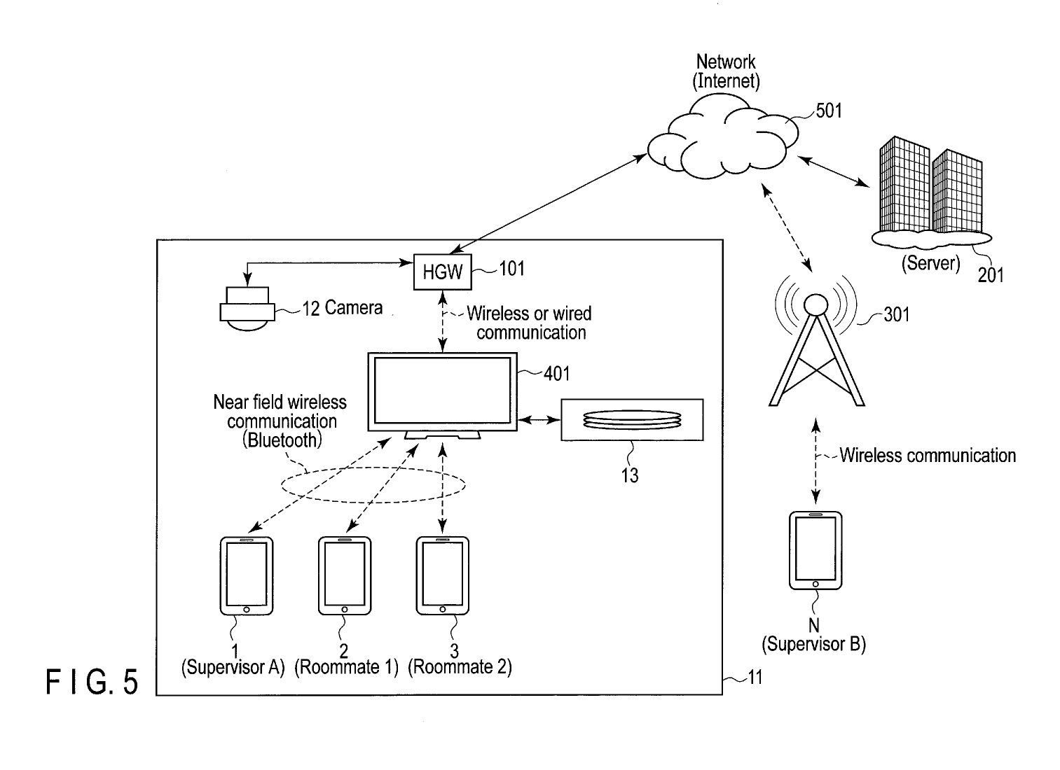

FIG. 5 is a schematic diagram for describing a relation between the electronic apparatus used in a predetermined space, for example, in an arbitrary indoor place such as living room in the house, the camera acquiring a video recording the space, and various associated elements.

As illustrated in FIG. 5, the camera 12 and the electronic apparatus (for example, a television 401 which receives a broadcasting program and reproduces the video and the voice (sound)) are placed at a predetermined position in the living room 11. The camera 12 makes a communication with a home gateway (hereinafter, referred to as HGW) 101 in the living room 11. The HGW 101 is connected to the storage device 13 through the television 401, and can store the video captured by the camera 12 in the storage device 13. In addition, the HGW 101 makes a communication with an external service server 201 through a network (Internet) 501. Further, the HGW 101 may be integrally provided with the camera 12. In addition, the storage device 13 may be provided integrally with the television 401. In addition, the HGW 101 may be provided integrally with the television 401.

In the example illustrated in FIG. 5, the television 401 can transfer information, for example, through Bluetooth (near field wireless communication) between the portable terminal devices 1, 2, . . . , and N (N is a positive integer) carried by the supervisor, the family members of the supervisor, or a visitor placed in the living room 11, the house, or the site. The portable terminal devices 1, 2, . . . , and N are, for example, smartphones, portable telephones, tablet PCs, or wearable terminals, and may be any form of devices as long as the device is carried by the supervisor, the family members of the supervisor, and a visitor (or attached to the user's body). The portable terminal devices 1, 2, . . . , and N can transfer information with respect to the server 201 through a public telecommunication network 301 (for example, a portable line) in a communication range of the near field wireless communication.

In this way, in the embodiment illustrated in FIG. 5, the operation (the presence/absence of the capturing) of the camera 12 can be set according to the presence/absence of the portable terminal devices 1, 2, . . . , and N (the owners of the portable terminal devices) which are mainly placed in a room where the television 401 is placed. Therefore, it is possible to make a detail setting to operate (capture) the camera 12 under a situation “only children stay in the room of the television 401” for example. In addition, for example, in a case where it is detected that there is an unregistered portable terminal device X in a situation “only children stay in the room of the television 401”, there is a merit on that the video captured by the camera 12 can be sequentially confirmed in the portable terminal device carried by the supervisor A (or the supervisor B).

Further, the condition for operating the camera 12 has been described in FIG. 5 about a case where only children stay in the room where the television 401 is placed. However, it is also applicable to a case where only an aged person stays. In this case, for example, a falling accident or such a symptom can be detected according to an unpredictable behavior of the aged person.

Further, the determination on a person who stays in the room where the television 401 is placed may be performed by the HGW 101, or may be performed by the server 201 through the network 501.

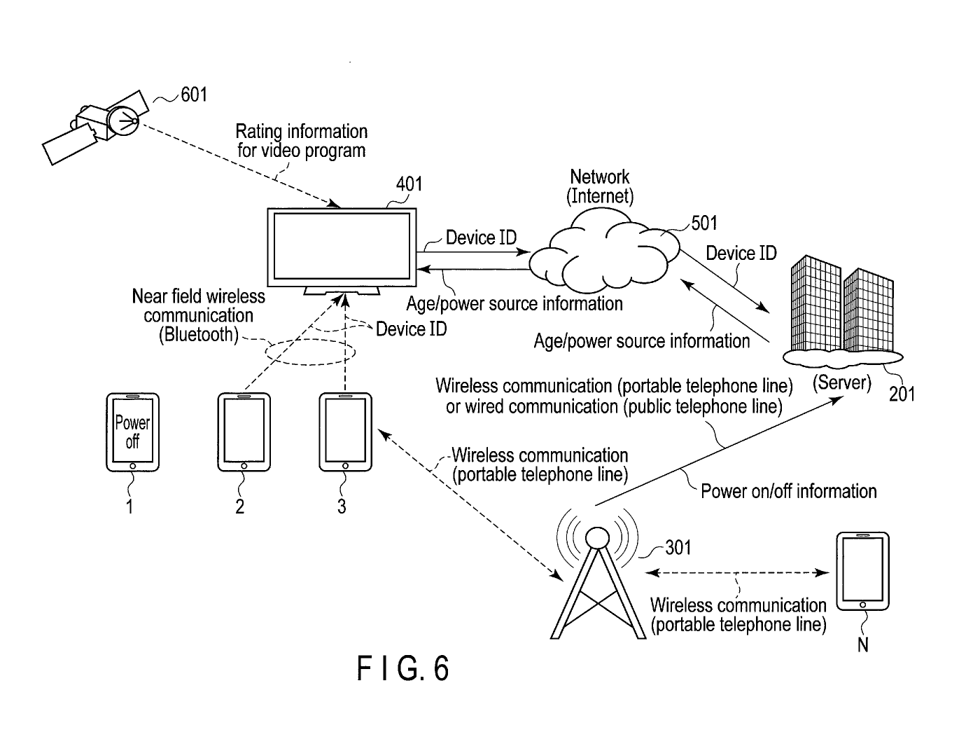

FIG. 6 illustrates an example of setting the operation of the television in a predetermined space (for example, the living room where the television is placed) on the basis of information specified to the electronic device placed in the living room (that is, the portable terminal device carried by each person who stays in the living room).

As illustrated in FIG. 6, in a predetermined space (for example, the living room 11) where the television 401 is placed, the television 401 communicates through the near field wireless communication (Bluetooth) with the portable terminal devices 1, 2, 3, . . . , and N (N is a positive integer) of the supervisor A (the portable terminal device 1) (for example, the father who stays in the space), the roommate 1 (the portable terminal device 2) who is a family member of the supervisor A, the roommate 2 (the portable terminal device 3) who is a family member of the supervisor A, and the supervisor B (mother) who is a family member of the supervisor A. Therefore, the television 401 can specify a person who stays in the living room 11. However, a person who stays in the living room 11 with the portable terminal device turned off or without carrying the portable terminal device may also be estimated. Therefore, it is determined whether a person having no portable terminal device stays in the living room and/or the power of the portable terminal device is turned off according to a sequence to be described below. Further, the determination on a person who stays in a room where the television 401 is placed may be performed by the television 401, or may be performed by the server 201 through the network 501.

As illustrated in FIG. 6, the television 401 communicates with each of the portable terminal devices 1, 2, 3, . . . , and N through the near field wireless communication. Further, in the example of FIG. 6, it is assumed that the roommate 1 (the portable terminal device 2) who stays in the same room with the supervisor A is a child, about 17 years old, of the supervisor A, and the roommate 2 (the portable terminal device 3) is a child, less than 10 years old, of the supervisor A. In addition, in the example of FIG. 6, the supervisor B (the portable terminal device N) who is the mother (a family member of the supervisor A) not staying in the living room 11 communicates with the television 401 through a wireless communication (portable telephone line) or the wired communication (public communication line) 301 and the network 501. Therefore, the supervisor B (the portable terminal device N) who does not stay in the living room 11 can be notified that the supervisor B is placed at a position away from the television 401 (out of a range of the near field wireless communication). In other words, the television 401 can grasp that the portable terminal device N (the supervisor B) does not stay in the living room 11. Naturally, in a case where the supervisor who does not stay in the living room 11 is the supervisor A, the television 401 can grasp that the portable terminal device 1 (the supervisor A) does not stay in the living room 11 similarly.

The television 401 reproduces videos and voices (sounds) of an arbitrary broadcasting program from a broadcasting satellite (broadcasting station) 301 for example. The broadcasting program reproduced by the television 401 complies with rating information (in the broadcasting program, the rating information is displayed in an overlapping manner). The television 401 can transfer the information with respect to the external server 201 through the network (Internet) 501.

In addition, the television 401 can transfer the information through the near field wireless communication (for example, Bluetooth (registered trademark)) between the portable terminal devices 1, 2, 3, . . . , N−1, and N (N is a positive integer) carried by the user, a family member of the user, and the visitor who stay in the living room, the house, or the site. Further, a mechanism for detecting the portable terminal device having a function of the near field wireless communication is connected to the television 401, and the information of the detected portable terminal device may be provided to the television 401.

The portable terminal devices 1, 2, 3, . . . , and N are, for example, smartphones, portable telephones, tablet PCs, or wearable terminals, and may be any form of devices as long as the device is carried by the user (or attached to the user's body). The portable terminal devices 1, 2, 3, . . . , and N can transfer information with respect to the server 201 through a public telecommunication network 301 (for example, a portable line) in a communication range of the near field wireless communication.

The television 401 receives and reproduces the broadcasting program which is selected by a viewer (user) among the broadcasting programs (also referred to as contents) supplied by transmission (broadcasting) through a space wave or by distribution through the network. Further, the broadcasting program (contents) may be acquired by accessing (referring or selectively acquiring (downloading)) a content server (a provider of the broadcasting program). In addition, the elements and configurations described below may be realized in terms of software by a microcomputer (processing device or CPU (Central Processing Unit)), or may be realized in terms of hardware. Further, the broadcasting program may be called a stream or information, and contains a video and a sound or music pertained to the video. In addition, the video includes a moving image, a still image, a text (information expressed by characters or symbols indicated by code strings), or an arbitrary combination thereof.

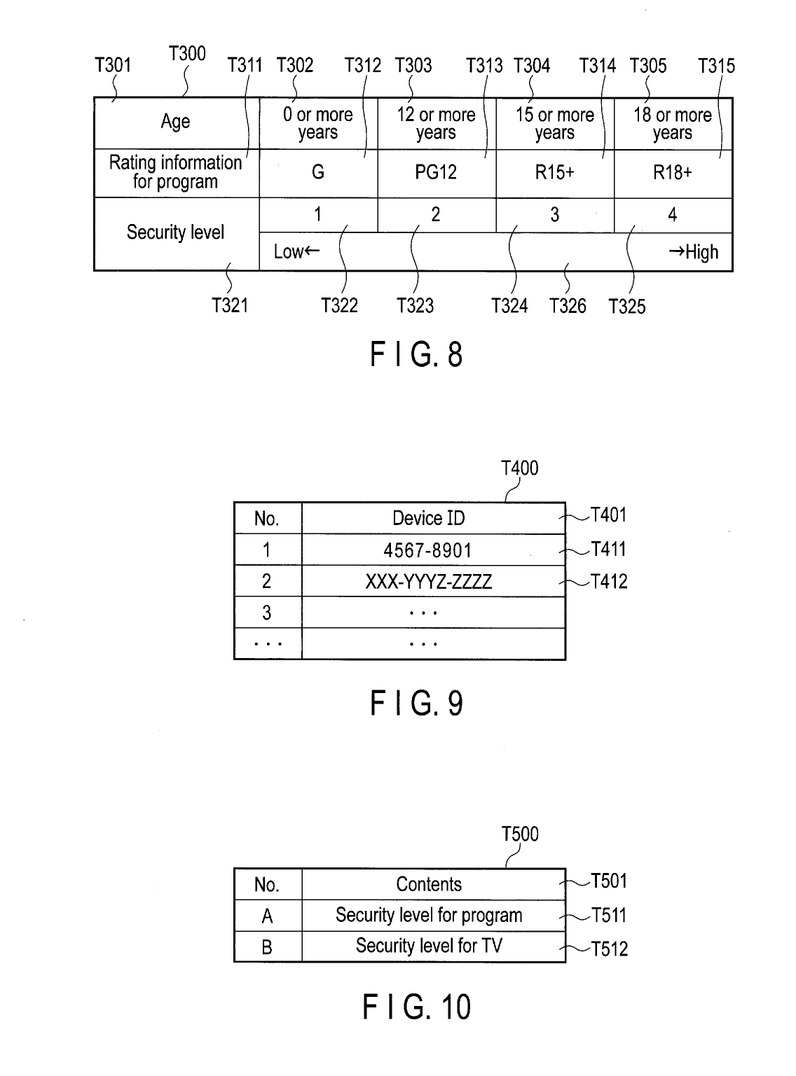

By the way, the broadcasting program includes the rating as described above. In many cases, the rating is set in advance to the broadcasting program containing, for example, a horror scene or a scene not appropriated to a young viewer by a broadcasting station or a provider of the broadcasting program. The rating includes, for example, an age section T301, rating information T311 of the broadcasting program, and a security level T321 as illustrated in a table T300 in FIG. 8.

The age section T301 includes a section T302 in which all the viewers up to 11 years old are allowed to view, a section T303 in which the viewers equal to or more than 12 years old are allowed to view, a section T304 in which the viewers equal to or more than 15 years old are allowed to view, and a section T305 in which the viewers equal to or more than 18 years old are allowed to view.

The rating information T311 of the broadcasting program includes a “G” sign T312 indicating the section T302 in which all the viewers up to 11 years old are allowed to view, a “PG12” sign T313 indicating the section T303 in which the viewers equal to or more than 12 years old are allowed to view, a “R15+” sign T314 indicating the section T304 in which the viewers equal to or more than 15 years old are allowed to view, and a “R18+” sign T315 indicating the section T305 in which the viewers equal to or more than 18 years old are allowed to view.

The security level T321 can be set independently of the security level T311 of the broadcasting program in the television 401. For example, a “1” sign T322 corresponds to the section T302 in which all the viewers up to 11 years old are allowed to view, a “2” sign T323 corresponds to the section T303 in which the viewers equal to or more than 12 years old are allowed to view, a “3” sign T324 corresponds to the section T304 in which the viewers equal to or more than 15 years old are allowed to view, and a “4” sign T325 corresponds to the section T305 in which the viewers equal to or more than 18 years old are allowed to view. Further, the security level T321 may be called “high (increase)” and “low (decrease)”.

In many cases, the broadcasting program set in advance by the broadcasting station or the provider of the broadcasting program is provided. In the current security method, in a case where the supervisor A carrying with the portable terminal device 1 views the broadcasting program of security information of “R18+”, the roommate 1 (carrying with the portable terminal device 2) or the roommate 2 (carrying with the portable terminal device 3), or the visitor (carrying with the portable terminal device X) come to view the broadcasting program.

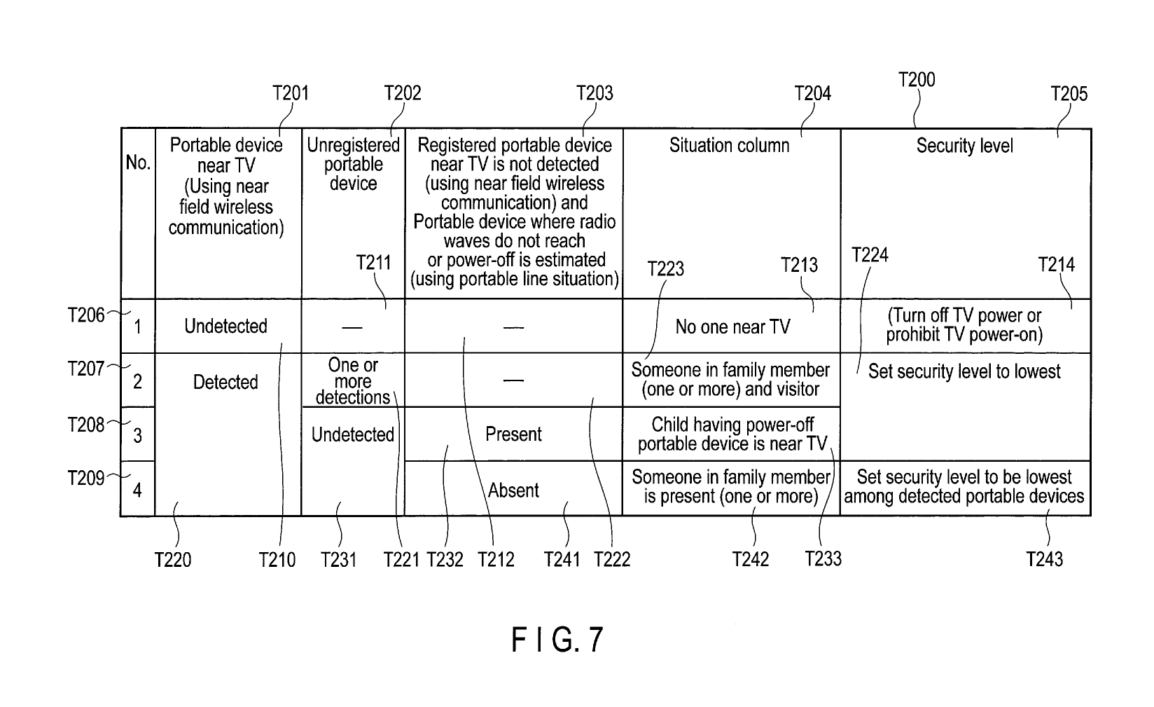

From such a background, nowadays, a possibility of viewing is set for every broadcasting program in the television 401 independently of the security level T311 of the broadcasting program as illustrated in FIG. 7 on the basis of the information specified to the viewers linked to the portable terminal devices carried by most of all the viewers (user). Therefore, it is possible to suppress a possibility to view a broadcasting program which is not intended by the viewer on the basis of a situation that the viewer (user) stays. As an example, in a case where one of the persons (users) carrying with the portable terminal device 2 (17 years old), the portable terminal device 3 (9 years old), and the portable terminal device X (visitor) stays, it is possible not to reproduce the broadcasting program of “R18+” (not to be viewed). On the other hand, if the child turns 15 years old, the broadcasting program of the “R15+” viewing age restriction comes to be viewable in the television 401 without changing the security level.

FIG. 7 illustrates a relation of the number of portable terminal devices (the number of viewers) detected by the television 401 and the power ON/OFF of the television 401.

A security level lookup table T200 illustrated in FIG. 7 includes, for example, a detection determination column T201 indicating whether one or more portable terminal devices are present near the television 401, a determination column T202 indicating whether an unregistered portable terminal device is present among the detected portable terminal devices, a detection determination column T203 indicating whether there is detected a portable terminal device which is registered but not detected near the television 401, a situation column T204 indicating a determination situation, and a setting level column T205 indicating the security level to be set. It is possible to suppress a possibility to view the broadcasting program which is not intended by the viewer by setting the respective cases (for example, the power-on of the television 401 and the application of viewing restriction) of the case numbers T206, T207, T208, and T209 with respect to the respective columns illustrated in FIG. 7.

In the detection determination column T201, in a case where any portable terminal device is not detected (T206), it is determined that there is no registered portable terminal device near the television 401 (T210). In this case, it is determined that the unregistered portable terminal device is also not presented (T211). Further, when any portable terminal device is not detected (T206), it is determined whether the respective registered portable terminal devices are in a state where the power is off (for example, a circumstance “radio waves do not reach”) using the public communication line. In other words, in a case where it is detected through the public communication line that the power of the registered portable terminal devices each or a predetermined number of portable terminal devices is on, it can be determined that there is no registered portable terminal devices near the television 401 (T212). Therefore, when where any portable terminal device is not detected (T206), it can be specified that there is no one near the television 401 by a situation determination column T213 in a case where it is determined that there is no registered portable terminal device near the television 401 in T212. In this case, the power of the television 401 is set not to be turned on. Further, in a case where it is not possible to detect any one of the portable terminal devices because the power of the television 401 is turned on, the power of the television 401 is turned off (T214).

In the detection determination column T201, in a case where one or more registered portable terminal devices are detected (T207, T208, and T209), the power of the television 401 is set to be turned on according to the presence/absence of the unregistered portable terminal device (T220).

In a case where one or more registered portable terminal devices are detected and one or more unregistered portable terminal devices are detected (T221/T207), it is determined that at least one of the family members (occupants in the house) and someone (for example, a visitor) carrying with the unregistered portable terminal device stay (T223) regardless of the determination result (T212) on a state whether it can be estimated that the power is turned off, for example, each of the registered portable terminal devices is in the circumstance “radio waves do not reach” (the determination of the detection determination column T203 is not performed). In this case, the security level for the television 401 is set to the “lowest level”, that is, a “level” to allow only the broadcasting program which can be viewed by the viewers of all ages (equal to or more than 0 age) illustrated in FIG. 8 (T224).

In a case where one or more registered portable terminal devices are detected and the unregistered portable terminal device is not detected (T222/T208), and in a case where it is detected that it can be estimated that the power is turned off (for example, each of the registered portable terminal devices is in the circumstance “radio waves do not reach”) (T232), it is determined that at least one of the family members (occupants in the house) and someone who turns off the power of the portable terminal device stay (T233). In this case, the security level for the television 401 is set to the “lowest level”, that is, a “level” to allow only the broadcasting program which can be viewed by the viewers of all ages (equal to or more than 0 age) similarly to the case where it is determined that a visitor stays (T224).

In a case where one or more registered portable terminal devices are detected and the unregistered portable terminal device is not detected (T231/T209), and in a case where it is detected that it can be estimated that the power is turned off (for example, each of the registered portable terminal devices is in the circumstance “radio waves do not reach”) (T241), it is determined that at least one of the family members (occupants in the house) turns on the power of the television 401 and the broadcasting program is viewable (T242). In this case, the security level to the television 401 is set to the “lowest security level among the detected portable terminal devices” (T243). For example, in a case where there is no one (user) who carries with the portable terminal device 2 (17 years old) and the portable terminal device 3 (9 years old), the broadcasting program of “R18+” is disabled to view. Therefore, it is possible to suppress a possibility to view a broadcasting program which is not intended by the viewer on the basis of a situation that the viewer (user) stays. Further, the determination on the presence/absence of the portable terminal device placed in the circumstance “radio waves do not reach” may be performed by the television 401, or may be performed by the server 201 through the network 501. In addition, the determination on the presence/absence of the portable terminal device placed in the circumstance “radio waves do not reach” may be performed between the portable terminal device and the server 201, and the television 401 may receive the determination result from the server 201.

FIG. 9 illustrates an example that a device ID which can be used to identify the portable terminal device (registered one). As the device ID, a MAC (Media Access Control) address which is unique to the portable terminal device, a telephone number, or an e-mail address may be used. The device ID is, for example, associated with serial Nos. 1, 2, 3, . . . , and device IDs T411, T412, . . . , illustrated in a device ID column T401 as illustrated in a table T400, and stored in a predetermined storage region of the server 201. Naturally, the television 401 may store the device ID in an inner storage region. Further, the television 401 may acquire the MAC address, the telephone number, or the e-mail address from each portable terminal device in a setting mode. In addition, the device ID of the portable terminal device may be acquired by the server 201 through the television 401 at a predetermined update time when the television 401 communicates with the server 201.

FIG. 10 illustrates an example of a display in which the security level to be set independently of the security level T311 (see FIG. 8) of the broadcasting program and the security level of the broadcasting program are selectable in the television 401. For example, a security management table T500 is read out from a menu screen for reference in the setting mode, any one of the security level A (the security level of the broadcasting program set by a provider of the broadcasting program) T511 and the security level B (the security level set in each TV) T512 illustrated in a content column T501 may be set. The security management table T500 may be stored in the storage region in the television 401 for example. In a case where the security level T512 of the television is selected in the security management table T500, for example, the security level T321 of the rating table T300 illustrated in FIG. 8 is read, and any one of “1” sign T322, “2” sign T323, “3” sign T324, and “4” sign T325 is desirably selected according to an input setting of the viewer (supervisor). Each of “1” sign T322, “2” sign T323, “3” sign T324, and “4” sign T325 is desirably selected by a setting method in which one of them is automatically selected and set like a sequential display of a toggle type (rotary type) or a radio button display (in a case where no one is selected, the display does not end). Further, the security level T321 may be intuitively selected in a slide type in a range of “high (increase)” and “low (decrease)”, for example, a seek bar which is display integrally with a locator (position display part).

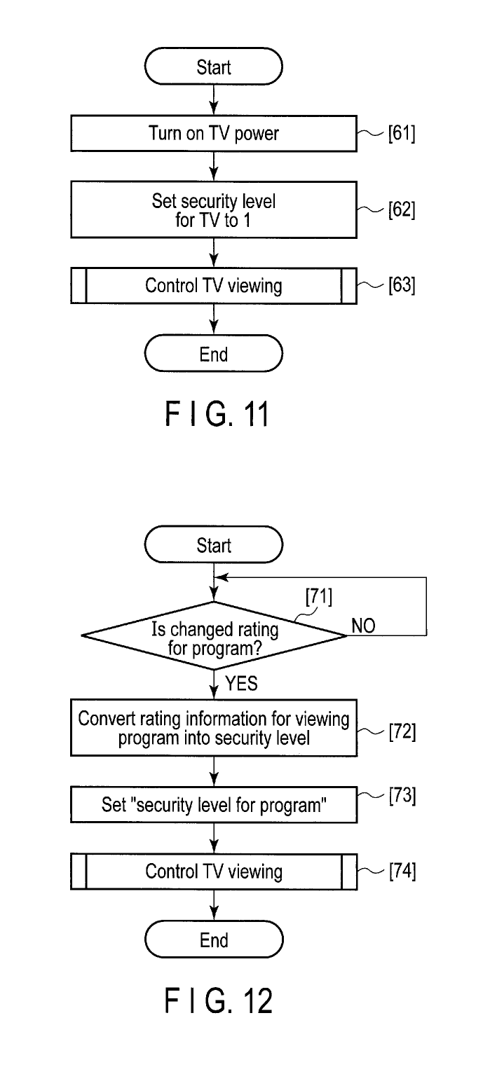

FIGS. 11, 12, 13, and 14 illustrate the relation between the number of portable terminal devices (the number of viewers) detected by the television and the power ON/OFF of the television described using FIG. 7 in a software manner.

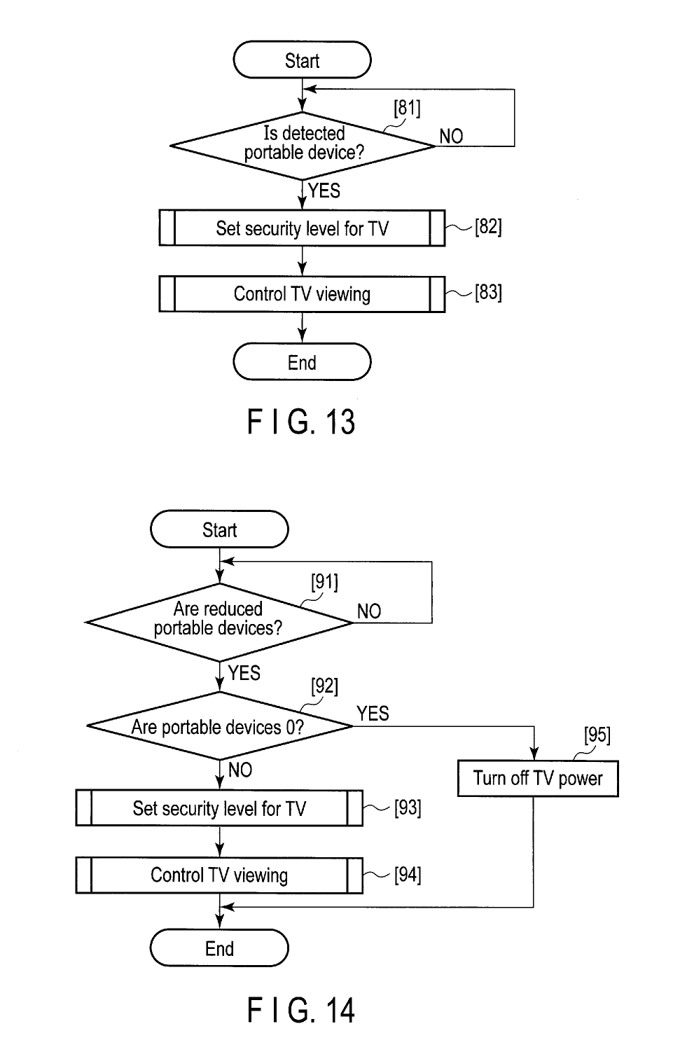

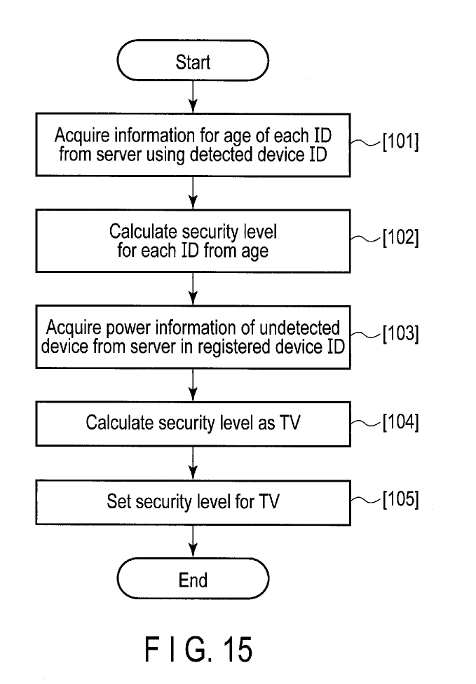

As shown in FIG. 11, in a case where the power of the television 401 is turned on [Block 61], the television 401 sets the own security level to “1” (see T322 of FIG. 8) [Block 62]. Hereinafter, the viewing control (to be described below using FIG. 15) starts in accordance with the age of the viewer who can be estimated staying in a viewing circumstance on the basis of the detection result of the portable terminal device illustrated in FIG. 13 or FIG. 14 [Block 63].

As shown in FIG. 12, in a case where it is detected that the broadcasting program ends during the viewing, or the rating of the broadcasting program is changed by switching the channel (the broadcasting program) [Block 71—YES], the rating information of the detected broadcasting program is changed to the security level of the broadcasting program [Block 72]. The television 401 sets the “security level of the broadcasting program” as the own security level [Block 73]. Hereinafter, the viewing control (to be described below using FIG. 15) starts in accordance with the age of the viewer [Block 74].

As shown in FIG. 13, in a case where the television 401 detects the portable terminal device [Block 81—YES], the own security level is set on the basis of the age information of the detected portable terminal device [Block 82]. Hereinafter, the viewing control (to be described below using FIG. 15) starts in accordance with the age of the viewer [Block 83].

Further, when a distance between the television 401 and the portable terminal device which is determined not to place near the television 401 is set for each registered portable terminal device, the viewing restriction of the detected broadcasting program can be set, for example, in a case where a child now staying in a room near the room of the television 401 moves to the living room with the portable terminal device. In addition, even when the television 401 detects the portable terminal device carried by the child who stays in the room near the room of the television 401, the viewing allowance may be performed from the portable terminal device carried by the father to release the viewing restriction. However, as described above, in a case where the child staying in the room near the room of the television 401 moves to the living room with the portable terminal device, the viewing restriction is set to the broadcasting program even after the viewing restriction is released.

As a method of determining “Not placed nearby” for every portable terminal device, for example, in a state where the television 401 detects the target portable terminal device through the near field wireless communication, the owner of the portable terminal device is set to be away from the television 401 and a radio wave intensity at the time when the owner enters the next room is stored. Therefore, it is possible to detect that the terminal owner approaches the television 401 at a time point when a strong intensity compare to the radio wave intensity is detected. In this case, a distance of the portable terminal device carried by the supervisor (father) to be determined as “Not placed nearby” is set to be shorter than the distance of the portable terminal device carried by the child to be determined as “Not placed nearby”. For example, in a case where the father views the broadcasting program restricted in children ages, the viewing restriction of the broadcasting program can be set by detecting that the child approaches the room of the television 401. In addition, in a case where the father is away from the room of the television 401, the viewing restriction may be set to the broadcasting program reproduced by the television 401 even only a short distance away.

As illustrated in FIG. 14, in a case where the television 401 detects a change (for example, reduction) in the number of portable terminal devices [Block 91—YES], it is detected whether the number of portable terminal devices is “0” (whether the number is “1” or more) [Block 92].

In a case where the number of portable terminal devices is “0” [Block 92—YES], the power of the television 401 is turned off [Block 95].

In a case where the number of portable terminal devices is not “0” (“1” or more) [Block 92—NO], the security level is set on the basis of the age information of the detected portable terminal device [Block 93]. Hereinafter, the viewing control starts in accordance with the viewer age described in FIG. 15 [Block 94].

Further, the settings of the security level illustrated in FIG. 13 and FIG. 14 both may be performed in combination. In addition, the setting of the security level illustrated in FIG. 12 may be also performed in combination.

In addition, the viewer of the setting target (the viewing restriction) of the security level may be set on the basis of not only the age but also various conditions such as male/female, the same room with an aged person (staying together), and viewing only for the viewer (the viewing is possible only when the other portable terminal devices are “Not placed nearby”).

FIG. 15 illustrates the setting of the security level in the television 401 in a software manner.

The television 401 acquires the age information corresponding to the detected device ID from the server [Block 101].

Next, the security level is calculated from the acquired age information. In other words, the television 401 estimates whether there is someone else nearby who is allowed to view the broadcasting program on the basis of the acquired age information [Block 102].

In addition, the television 401 acquires power source information (whether the power is turned on) of the terminal device which is not detected among the registered portable terminal device. In other words, for example, it is determined whether a child who has the power-off portable terminal device stays nearby on the basis of the determination condition illustrated in FIG. 7 in a situation where the supervisor A (or the supervisor B) tries to view the broadcasting program of the viewing age restriction [Block 103].

Subsequently, the television 401 calculates the security level to be set to the own device [Block 104].

The television 401 then sets the calculated security level of the television to the own device [Block 105].

Therefore, it is possible to suppress a possibility to view a broadcasting program which is not intended by the viewer on the basis of a situation that the viewer (user) stays. For example, the broadcasting program hardly viewed is automatically set not to be viewed in a case where the visitor stays. Since, the portable terminal device (terminal device X) of the visitor is detected. In addition, in a case where a child having the power-off portable terminal device stays nearby, it is possible to suppress that the broadcasting program of the viewing age restriction is carelessly set to be viewed.

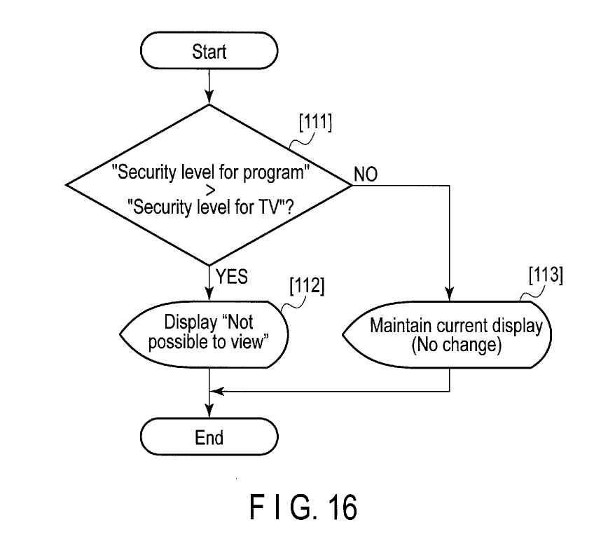

FIG. 16 illustrates an exemplary operation of the television on the basis of the security level set in the television and the security level set in the broadcasting program set in the television in a software manner.

As illustrated in FIG. 16, first, the security level of the broadcasting program is compared to the security level of the television 401 [Block 111].

In a case where the security level of the broadcasting program is higher than the security level of the security level of the television (“the security level of the broadcasting”>“the security level of the television” is established) [Block 111—YES], a display signal is output to display, for example, “Viewing is not possible” in a display unit [Block 112].

In a case where the security of the broadcasting program is lower than the security level of the television (“the security level of the broadcasting program”<“the security level of the television” is established) [Block 111—NO], the current display is maintained (kept on) [Block 113].

In this way, according to the embodiment, in a case where there are a plurality of portable terminal devices when a parental lock (the viewing restriction in which the age is a basis) of the television is released in the allowed portable terminal device by the near field wireless communication between the portable terminal device and the television, the parental lock can be maintained as long as all the portable terminal devices are not allowed. Therefore, it is possible to suppress that the broadcasting program comes to be viewable regardless of the intention of the viewer on the basis of a situation that the viewer having the portable terminal device stays.

In addition, according to the embodiment, a setting level of the parental lock of the television can be controlled with respect to a person having the portable terminal device on the basis of information specified to a person who is linked to the portable terminal device, for example, the date of birth or the age which are registered.

In addition, according to the embodiment, the setting level of the parental lock can be controlled for every broadcasting program. In other words, in a case where it is detected that the rating of the broadcasting program is changed when the currently-viewing broadcasting program ends or the channel (the broadcasting program) is switched, the parental lock is newly set for the broadcasting program. In other words, for example, in a case where, the broadcasting program of “R15+” is broadcasting in the channel that the child changes in the middle of that the father tries to view the broadcasting program having no age restriction together with the child (10 years old) in the same room without any change the age restriction after the father (supervisor) viewed the broadcasting program of “R15+”, the television performs the control not to reproduce the broadcasting program (the video is not displayed, and also the sound is not output).

In addition, according to the embodiment, in a case where the (registered) portable terminal device allowed to view the broadcasting program and the (unregistered) portable terminal device not allowed are mixed, the parental lock can be released by operating the viewing allowance using the portable device which is allowed to view the broadcasting program.

In addition, according to the embodiment, in a case where the portable terminal device can perform a long-distance communication (grasping a circumstance that the power-on of the portable terminal device and the radio waves do not reach using the public communication line) and the near field wireless communication (grasping a distance between the portable terminal device and the television), and the power of the portable terminal device is turned on, an effective distance with respect to the television can be set for every portable terminal device.

In addition, according to the embodiment, in a case where the power-on state of the portable terminal device is not possible to be grasped using the public communication line, the distance (near or far) between the television and the portable terminal device is determined by the near field wireless communication between the television and the portable terminal device. In other words, in a case where it is not possible to grasp whether the power of the terminal is turned on using the long-distance communication function of the portable terminal device, the parental lock is not released. Therefore, even in a case where “Not placed nearby” is determined through the near field wireless communication, it is possible to detect a possibility that the power-off portable terminal device (that is, the guardian) is placed near. Accordingly, in a case where a child having the power-off portable terminal device stays nearby, it is possible to suppress that the broadcasting program of the viewing age restriction is carelessly viewed.

In addition, according to the embodiment, in a case where it is detected that there is no one portable terminal device, the power of the television is set to be turned off. Therefore, even when the power of the television is turned on to view the broadcasting program in a situation where there is no one staying, the viewing itself can be suppressed.

In this way, in a situation that various persons having the portable terminal devices are gathered, it is possible to suppress that the contents to be originally suppressed from being reproduced and inappropriate information is undesirably reproduced (to be viewed by the gathered various persons), or that the contents and the information are viewed due to carelessness such as forgetting to set the security.

Further, the television may be a photo frame device, a PC (personal computer), or an electronic bulletin board, and the information (contents) to be displayed/not to be displayed may be a message (memo) between the family members or a public announcement (open all) in a company or a school.

In addition, the HGW may be a passage sensor which detects entering/leaving, and an entrance management device which allows an entrance to a business category or a government-controlled competitive hall in a security gate, or may be replaced with various elements which can use the information specified to the guardian of the portable terminal device linked to the portable terminal device. In this case, the entrance is allowed only in a case where all the companions are confirmed to satisfy the restriction condition using an ambient environment of the guardian of the portable terminal device (for example, using the specific information acquired from the portable terminal device carried by companions (if anybody)).

Further, while the embodiment has been described about that the portable terminal device “placed near” the television is detected, the portable terminal device carried by the guardian near the television may notify “in a close state” to the television. For example, “in a close state” may be notified to the television by transmitting a wake-up signal from the portable terminal device in the close state with respect to the television of which the power is turned off. In such a case, the fact that the video is not possible to be displayed and the sound is not possible to be reproduced by the viewing restriction is desirably displayed in a screen so that the viewer (user) is not wondering about that the television is not turned on even though the power of the television is turned on. In such a case, a friendly message is desirably displayed in accordance with the age of the viewer (the guardian of the portable terminal device) which can be specified by the detected portable terminal device. For example, a message “Please watch with your father or mother” may be displayed to a child less than 12 years old, and a message “Please wait more 3 years (in the broadcasting program of “R18+”)” may be displayed to a child of 15 years old.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

Further, the above embodiments may be realized by the following configuration.

An electronic apparatus includes
a communicator which can wirelessly communicate with an electronic device within a first communication distance among an electronic device associated with a user of an age equal to or less than a threshold and an electronic device associated with a user of an age higher than the threshold, and
a processor unit which performs a first processing for the age equal to or less than the threshold in a case where a plurality of electronic devices are placed within the first communication distance and at least one of them is a first electronic device associated with the user of the age equal to or less than the threshold, and a second processing different from the first processing for the age higher than the threshold in a case where the plurality of electronic devices are placed within the first communication distance and all of them associated with the user of the age higher than the threshold.

What is claimed is:

1. An electronic apparatus configured to control a camera, comprising:
communication circuitry capable of communicating with a first electronic terminal of a first user or a second electronic terminal of a second user, when a plurality of electronic terminals comprising the first electronic terminal and the second electronic terminal are located within a first communication distance from the electronic apparatus; and
processor circuitry configured to:
start a capturing of the camera when the first electronic terminal is located outside of the first communication distance, and
stop the capturing of the camera when at least the first electronic terminal is located within the first communication distance.

2. The electronic apparatus of claim 1,
wherein the first user belongs to a first age group,
wherein the second user belongs to a second age group, and
wherein the first age group is higher than the second age group.

3. The electronic apparatus of claim 1, wherein the processor instructs the camera to capture in a case where the first electronic terminal and the second electronic terminal are not included in the electronic terminals within the first communication distance.

4. The electronic apparatus of claim 1, wherein the processor notifies that an electronic terminal, neither the first electronic terminal nor the second electronic terminal, is detected to at least the first electronic terminal by a second communication circuitry different from the communication circuitry in a case where the first electronic terminal and the second electronic terminal are not included in the electronic terminals within the first communication distance.

5. The electronic apparatus of claim 1, wherein the processor is capable of receiving an instruction on the camera to capture from the first electronic terminal by a second communication circuitry different from the communication circuitry even in a case where the first electronic terminal is not included in the electronic terminals within the first communication distance.

6. The electronic apparatus of claim 1,
wherein the communication circuitry is capable of acquiring information related to a distance to the first electronic terminal, and
wherein the processor instructs the camera to capture in a case where the distance to the first electronic terminal is equal to or more than a second distance even in a case where the first electronic terminal is included in the electronic terminals within the first communication distance.

7. A method, comprising:
communicating with an electronic terminal within a first communication distance among a plurality of electronic terminals at least including a first electronic terminal associated with a first user and a second electrode terminal associated with a second user;
instructing a camera to capture in a case where the first electronic terminal is not included in a plurality of electronic terminals within the first communication distance; and
stopping the capturing of the camera in a case where the first electronic terminal is included in the electronic terminals within the first communication distance.

8. The method of claim 7,
wherein the first user belongs to a first age group,
wherein the second user belongs to a second age group, and
wherein the first age group is higher than the second age group.

9. The method of claim 7, wherein the instructing includes instructing the camera to capture in a case where the first electronic terminal and the second electronic terminal are not included in the electronic terminals within the first communication distance.

10. The method of claim 7, wherein the instructing is to notify that an electronic terminal, neither the first electronic terminal nor the second electronic terminal, is detected to at least the first electronic terminal by a second communication circuitry different from a communication circuitry in a case where the first electronic terminal and the second electronic terminal are not included in the electronic terminals within the first communication distance.

11. The method of claim 7, wherein, in the instructing, an instruction on the camera to capture is capable of receiving from the first electronic terminal by a second communication circuitry different from a communication circuitry even in a case where the first electronic terminal is not included in the electronic terminals within the first communication distance.

12. The method of claim 7,
wherein information related to a distance to the first electronic terminal is acquired by communication, and
wherein the camera is instructed to capture in a case where the distance to the first electronic terminal is equal to or more than a second distance even in a case where the first electronic terminal is included in the electronic terminals within the first communication distance.
